(19) United States
(12) Patent Application Publication
(10) Pub. No.: US 2022/0277235 A1
(43) Pub. Date: Sep. 1, 2022

(54) OPTIMIZATION DEVICE, OPTIMIZATION METHOD, AND OPTIMIZATION PROGRAM

(71) Applicant: NIPPON TELEGRAPH AND TELEPHONE CORPORATION, Tokyo (JP)

(72) Inventors: Hidetaka ITO, Tokyo (JP); Tatsushi MATSUBAYASHI, Tokyo (JP); Takeshi KURASHIMA, Tokyo (JP); Hiroyuki TODA, Tokyo (JP); Masami TAKAHASHI, Tokyo (JP); Masahiro KOJIMA, Tokyo (JP)

(73) Assignee: NIPPON TELEGRAPH AND TELEPHONE CORPORATION, Tokyo (JP)

(21) Appl. No.: 17/630,868

(22) PCT Filed: Jul. 29, 2019
(86) PCT No.: PCT/JP2019/029682

§ 371 Date: Jan. 27, 2022

(51) Int. Cl. G06Q 10/06

(52) U.S. Cl. CPC G06Q 10/0631

(57) ABSTRACT

An optimization device includes a model construction unit that constructs a model for representing a relationship among groups and for obtaining a prediction represented as a time series based on a set of groups of occurrence time points of reference events as events occurring before interventions and intervention timings as time points to cause the interventions and a set of evaluation values of the groups, a parameter determination unit that acquires one or more occurrence time points of the reference events and determines the next group including a next intervention timing based on the acquired occurrence time points of the reference events, the constructed model, and an acquisition function for obtaining the next intervention timing, an evaluation unit that performs the intervention at the next intervention timing in the determined next group and calculates the evaluation value of the group obtained as the next group, and an assessment unit that causes construction of the model, determination of the group, and calculation of the evaluation value to be repeated until a predetermined condition is satisfied. In the repetition, the model is constructed based on the set of the groups and the set of the evaluation values which are obtained in each of the repeatedly performed interventions.

### TECHNICAL FIELD

The disclosed technique relates to an optimization device, an optimization method, and an optimization program.

### BACKGROUND ART

There is a case where encouragement for changing an action of a person is given from an outside such as a case where the person is advised to activate an application by sending a notification or a recommendation of the application of a smartphone. This encouragement will be referred to as intervention in the following. Performance of the above intervention may become a trigger to cause an intervened party to take an action intended by an intervening party.

Many techniques have been devised which predict when a person next takes a certain action from a past timing of the action of the person (see Non-Patent Literature 1).

Further, as a trial-and-error optimization technique which efficiently optimizes several parameters, Bayesian optimization has been used (see Non-Patent Literature 2).

### CITATION LIST

### Non-Patent Literature

Non-Patent Literature 1: Kim, H., Takaya, N. and Sawada, H., 2014, November. Tracking temporal dynamics of purchase decisions via hierarchical time-rescaling model. In Proceedings of the 23rd ACM International Conference on Conference on Information and Knowledge Management (pp. 1389-139 8). ACM.

Non-Patent Literature 2: Shahriari, B., Swersky, K., Wang, Z., Adams, R. P. and Freitas, de N.: Taking the human out of the loop: A review of bayesian optimization, Proceedings of the IEEE, Vol. 104, No. 1, pp. 148-175 (2016).

### SUMMARY OF THE INVENTION

### Technical Problem

However, in a case of an intervention as in Non-Patent Literature 1, it is meaningless to perform an intervention at a timing when a person naturally takes an action. Actually, because an intervention has to be performed not at a timing when the person naturally takes an action but at a timing when the person highly possibly accepts the intervention, a prediction from a past action is insufficient.

Further, as in Non-Patent Literature 2, it is known that Bayesian optimization can efficiently perform optimization by small numbers of trials and errors. However, usual Bayesian optimization only can optimize the values of a vector of plural collected parameters but cannot directly be applied to optimization of an intervention timing. Further, an element, which can be changed by an external factor, such as an action of a person prior to an intervention cannot be taken into consideration in Bayesian optimization.

An object of the present disclosure is to provide an optimization device, an optimization method, and an optimization program that can estimate an optimal intervention timing in accordance with a reference event.

### Means for Solving the Problem

A first aspect of the present disclosure provides an optimization device including: a model construction unit that constructs a model for representing a relationship among groups and for obtaining a prediction represented as a time series based on a set of groups of occurrence time points of reference events as events occurring before interventions and intervention timings as time points to cause the interventions and a set of evaluation values of the groups; a parameter determination unit that acquires one or more occurrence time points of the reference events and determines the next group including a next intervention timing based on the acquired occurrence time points of the reference events, the constructed model, and an acquisition function for obtaining the next intervention timing; an evaluation unit that performs the intervention at the next intervention timing in the determined next group and calculates the evaluation value of the group obtained as the next group; and an assessment unit that causes construction of the model, determination of the group, and calculation of the evaluation value to be repeated until a predetermined condition is satisfied, in which in the repetition, the model is constructed based on the set of the groups and the set of the evaluation values which are obtained in each of the repeatedly performed interventions.

A second aspect of the present disclosure provides an optimization method causing a computer to execute processes of: constructing a model for representing a relationship among groups and for obtaining a prediction represented as a time series based on a set of groups of occurrence time points of reference events as events occurring before interventions and intervention timings as time points to cause the interventions and a set of evaluation values of the groups; acquiring one or more occurrence time points of the reference events and determining the next group including a next intervention timing based on the acquired occurrence time points of the reference events, the constructed model, and an acquisition function for obtaining the next intervention timing; performing the intervention at the next intervention timing in the determined next group and calculating the evaluation value of the group obtained as the next group; and causing construction of the model, determination of the group, and calculation of the evaluation value to be repeated until a predetermined condition is satisfied, in which in the repetition, the model is constructed based on the set of the groups and the set of the evaluation values which are obtained in each of the repeatedly performed interventions.

A third aspect of the present disclosure provides an optimization program causing a computer to execute: constructing a model for representing a relationship among groups and for obtaining a prediction represented as a time series based on a set of groups of occurrence time points of reference events as events occurring before interventions and intervention timings as time points to cause the interventions and a set of evaluation values of the groups; acquiring one or more occurrence time points of the reference events and determining the next group including a next intervention timing based on the acquired occurrence time points of the reference events, the constructed model, and an acquisition function for obtaining the next intervention timing; performing the intervention at the next intervention timing in the determined next group and calculating the evaluation value of the group obtained as the next group; and causing construction of the model, determination of the group, and calculation of the evaluation value to be repeated until a predetermined condition is satisfied, in which in the repetition, the model is constructed based on the set of the groups and the set of the evaluation values which are obtained in each of the repeatedly performed interventions.

### Effects of the Invention

The disclosed technique can estimate an optimal intervention timing in accordance with a reference event.

### BRIEF DESCRIPTION OF DRAWINGS

FIG. 1 is a diagram illustrating an image of the relationship between a reference event and an intervention timing.

FIG. 2 is a diagram illustrating an outline of a flow of optimization of the intervention timing.

FIG. 3 is a block diagram illustrating a configuration of an optimization device of the present embodiment.

FIG. 4 is a block diagram illustrating a hardware configuration of the optimization device.

FIG. 5 is a diagram illustrating one example of a group of a group xₜ and an evaluation value Yₜ, the group being stored in an evaluation accumulation unit.

FIG. 6 is a flowchart illustrating a flow of an optimization process by the optimization device.

FIG. 7 is a diagram illustrating the relationship between an occurrence time point of a reference event and an intervention timing desired to be obtained.

### DESCRIPTION OF EMBODIMENTS

One example of an embodiment of the disclosed technique will hereinafter be described with reference to drawings. Note that the same reference characters are given to the same or equivalent configuration elements or portions in the drawings. Further, dimension ratios in the drawings are emphasized for convenience of descriptions and may be different from actual ratios.

First, an outline of the present disclosure will be described. Even when the same kind of intervention is performed, whether an intervened party accepts the intervention changes depending on a timing. For example, in an example of an application, the same kind of intervention is the same notification of the same application. For example, there is a case where a health application which records a health state of a user gives a notification to notify the health state of the user. In this case, in a state where the user has not opened the heath application for a certain period, it is highly possible that the user intends to check a recent health state which has not been checked and opens the health application in response to the notification. However, when the notification is issued although he/she has checked the health state immediately before, it is highly possible that he/she ignores the notification and does not open the health application. This indicates that an acceptance degree of an intervened party changes in accordance with a timing. Such an acceptance degree of an intervened party in accordance with the timing is different depending on each intervened party. Thus, it is necessary to optimize an optimal intervention timing for an individual as a person of an intervened party.

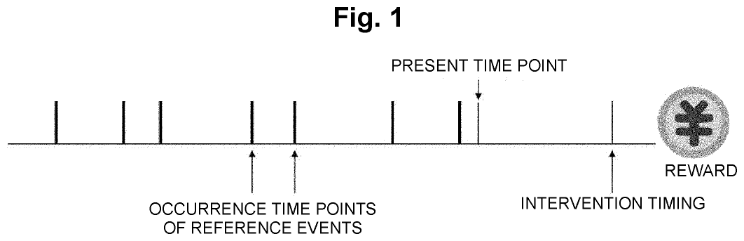

FIG. 1 is a diagram illustrating an image of the relationship between a reference event and an intervention timing. As illustrated in FIG. 1, an optimization device in the embodiment of the present disclosure assumes that an appropriate intervention timing is determined based on a relative time relationship with an occurrence time of a reference event as an event occurring before an intervention. A reference event is an event desired to be caused by an intervention or an event related to the event. The optimization device in the embodiment of the present disclosure determines an intervention timing to perform a next intervention based on an occurrence time of the reference event and performs the intervention at the intervention timing. Then, the optimization device in the embodiment of the present disclosure evaluates a reward of the intervention timing.

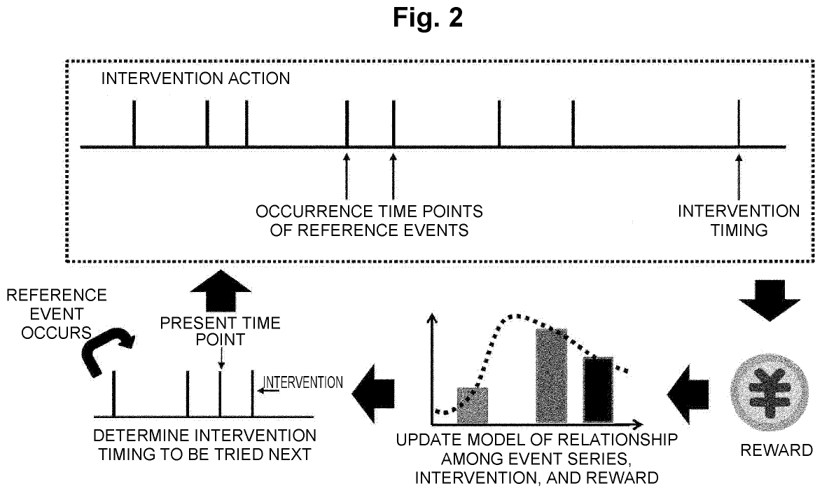

The technique of the present disclosure can optimize an intervention timing based on an occurrence time of an event as a reference. When an intervention is performed at an appropriate timing, an approach is possible which, at a higher frequency, causes an intervened party to take an action corresponding to an aim of an intervening party. Further, in a case where trial-and-error optimization is performed, a degree of subjective acceptance of an intervention by an intervened party can be predicted, and an intervention timing with a high action-changing effect can automatically be estimated. Furthermore, a procedure is used which is based on Bayesian optimization directly forming a model with a group of an occurrence time of a reference event and a timing of an intervention. Accordingly, a preferable timing of an intervention can be obtained by small numbers of trials and errors. FIG. 2 is a diagram illustrating an outline of a flow of optimization of the intervention timing. As illustrated in FIG. 2, by repetition by Bayesian optimization, a model is constructed which is for representing the relationship among groups and for obtaining prediction represented as a time series.

In the following, a configuration of the present embodiment will be described. In the following, as one example of the embodiment, a description will be made about a case where an increase in an application use time of a user of a certain smartphone application is set as a purpose. In this case, an event having an application activation history as a reference is set as a reference event, and an intervention is performed to advise the user to activate the application and to use the application for a long time based on this reference event. One example of the reward is the length of time in which the application is activated.

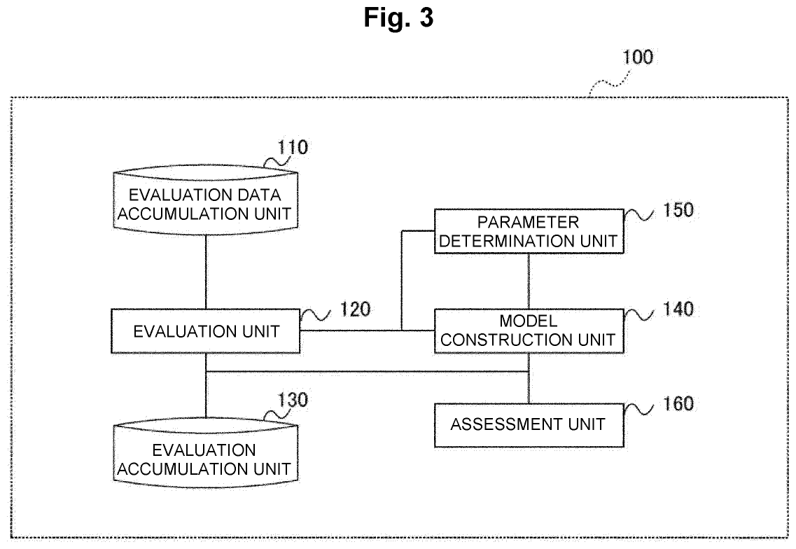

FIG. 3 is a block diagram illustrating a configuration of an optimization device of the present embodiment.

As illustrated in FIG. 3, an optimization device 100 is configured to include an evaluation data accumulation unit 110, an evaluation unit 120, an evaluation accumulation unit 130, a model construction unit 140, a parameter determination unit 150, and an assessment unit 160.

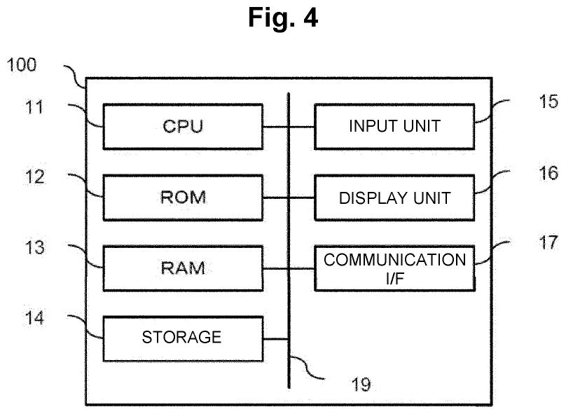

FIG. 4 is a block diagram illustrating a hardware configuration of the optimization device 100.

As illustrated in FIG. 4, the optimization device 100 has a CPU (central processing unit) 11, a ROM (read only memory) 12, a RAM (random access memory) 13, a storage 14, an input unit 15, a display unit 16, and a communication interface (I/F) 17. Configurations are connected together so as to be capable of mutual communication via a bus 19.

The CPU 11 is a central arithmetic processing unit, executes various kinds of programs, and controls the units. That is, the CPU 11 reads out a program from the ROM 12 or the storage 14 and executes the program with the RAM 13 being a working area. The CPU 11 performs control of the above configurations and various kinds of arithmetic processing following a program stored in the ROM 12 or the storage 14. In the present embodiment, an optimization program is stored in the ROM 12 or the storage 14.

The ROM 12 stores various kinds of programs and various kinds of data. The RAM 13, as a working area, temporarily stores a program or data. The storage 14 is configured with an HDD (hard disk drive) or an SSD (solid state drive) and stores various kinds of programs including an operating system and various kinds of data.

The input unit 15 includes a pointing device such as a mouse and a keyboard and is used for performing various kinds of inputs.

The display unit 16 is a liquid crystal display, for example, and displays various kinds of information. The display unit 16 may be employed as a display unit of a touch panel type and thereby function as the input unit 15.

The communication interface 17 is an interface for communication with another apparatus such as a terminal and uses a standard such as Ethernet(R), FDDI, or Wi-Fi(R), for example.

Next, each function configuration of the optimization device 100 will be described. The CPU 11 reads out the optimization program stored in the ROM 12 or the storage 14, expands that in the RAM 13, and executes that, and each of the function configurations is thereby realized. Note that details of a process will be described in work described later.

In the evaluation data accumulation unit 110, data necessary in performing evaluation of the reward is stored. One example of necessary data is a notification statement to an application. When data of the notification statement of an intervention at the intervention timing is arbitrarily changed, evaluation of the reward in accordance with the data can be performed.

The evaluation unit 120 performs an intervention at the next intervention timing in the next group determined by the parameter determination unit 150 described later. The intervention is performed by acquiring data from the evaluation data accumulation unit 110. After the intervention at the next intervention timing, the evaluation unit 120 calculates an evaluation value of a group obtained as the next group. Here, the next group is denoted as xₜ₊₁, the next intervention timing is denoted as τₜ₊₁, and the evaluation value of the next group xₜ₊₁ is denoted as yₜ₊₁. The evaluation unit 120 stores a group of the next group xₜ₊₁ and the evaluation value yₜ₊₁ in the evaluation accumulation unit 130. Details of the group will be described later.

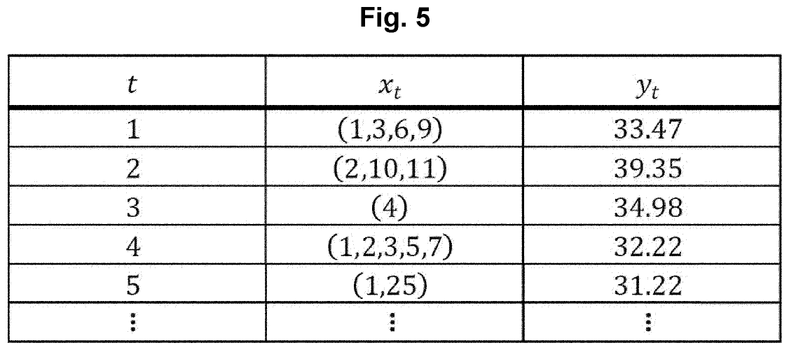

In the evaluation accumulation unit 130, the groups of the next groups xₜ₊₁ and the evaluation values Yt+i are stored by repetition. In other words, a group of a group xₜ and an evaluation value yₜ at the present point in the repetition is stored. FIG. 5 is a diagram illustrating one example of the group of the group xₜ and the evaluation value yₜ, the group being stored in the evaluation accumulation unit 130. As illustrated in FIG. 5, the group xₜ is a group of an occurrence time point t of the reference event (the activation history of the application in the present embodiment) and the intervention timing. The intervention timing may be considered as a prediction value to be predicted by a model. The evaluation value yₜ is the reward corresponding to the group xₜ. A set in which xₜ and yₜ are collected together will be expressed as X={xₜ|t=1, 2, . . . } and Y={yₜ|t=1, 2, . . . }. The evaluation accumulation unit 130 reads out those pieces of data in response to a request and outputs the data to a processing unit. Here, a term t denotes the tth intervention, and the group xₜ denotes the group of an occurrence time point of the reference event and the intervention timing. It is assumed that the group xₜ is a vector which records how earlier the reference event has occurred with an intervention time point (not illustrated) by the intervention timing being a base point. In the present embodiment, because optimization is performed in a trial-and-error manner, the reference event is different at each time of performance. Further, the reference event occurs due to a voluntary action of a person, the number of occurrences cannot be controlled. Thus, because the number of occurrences of the reference events is different at each time, the number of elements of the vector of the group xₜ is variable. Note that in a case where plural interventions are performed, it is assumed that a group xᵥ and an evaluation value yᵥ are present for each intervention.

The model construction unit 140 constructs a model based on a set X of groups of occurrence time points of the reference events and the intervention timings as time points to cause the interventions and a set Y of the evaluation values of the groups. The model is a model for representing the relationship among the groups and for obtaining a prediction represented as a time series, and as one example, a Gaussian process is used. At a start point of a process by the optimization device 100, the set X of the groups and the set Y of the evaluation values of the groups are obtained by preliminary evaluation. The preliminary evaluation will be described later. Then, the model construction unit 140 constructs the model based on the set X of the groups and the set Y of the evaluation values of the groups in each of interventions t repeatedly performed in repetition by the assessment unit 160. Accordingly, the model is optimized.

The parameter determination unit 150 acquires one or more occurrence time points of the reference events. The parameter determination unit 150 determines the next group including the next intervention timing based on the acquired occurrence time points of the reference events, the constructed model, and an acquisition function for obtaining the next intervention timing. Further, in a case where the reference event occurs before the determined next intervention timing, the parameter determination unit 150 may acquire the occurrence time points of the reference events including the occurred reference event and again perform determination of the next group including the next intervention timing.

The assessment unit 160 causes construction of the model, determination of the group, and calculation of the evaluation value to be repeated until a predetermined condition is satisfied. Whether the predetermined condition is satisfied is assessed based on whether the number of repetitions exceeds a defined maximum number, for example. One example of the maximum number of the number of repetitions is 1,000 times.

Next, the work of the optimization device 100 will be described.

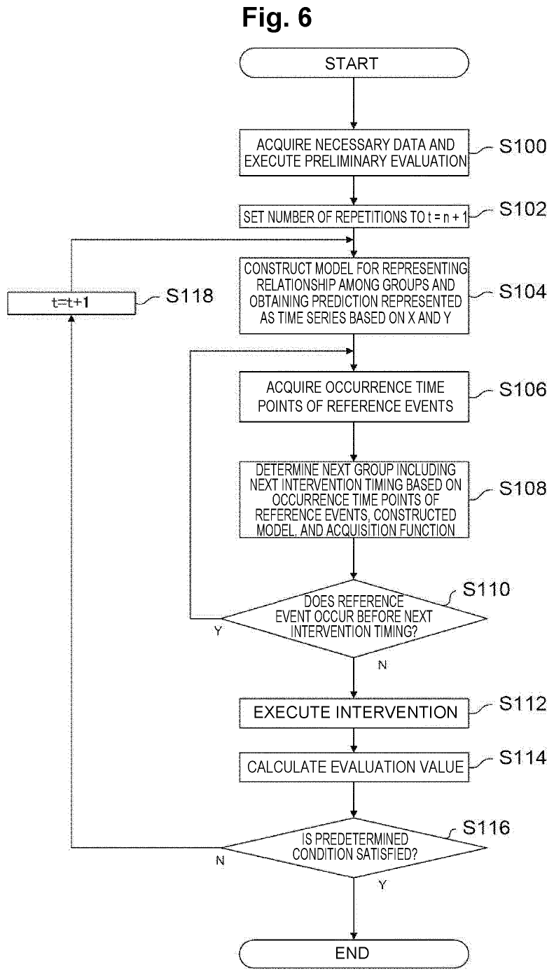

FIG. 6 is a flowchart illustrating a flow of an optimization process by the optimization device 100. The CPU 11 reads out the optimization program stored in the ROM 12 or the storage 14, expands that in the RAM 13, and executes that, and the optimization process is thereby performed.

In step S100, the CPU 11, as the evaluation unit 120, acquires data necessary for performing evaluation from the evaluation data accumulation unit 110. Further, the CPU 11 executes, n times, the preliminary evaluation for generating data for performing construction of the model and obtains a group xₖ of the preliminary evaluation and an evaluation value yₖ of the preliminary evaluation. Here, k=1, 2, . . . , n. The value of n is an arbitrary value. Further, a way of setting the intervention timing for performing the preliminary evaluation is an arbitrary way. For example, a method is used in which the intervention timing is selected by random sampling or manually selected. The preliminary evaluation may be performed similarly to steps S102 to S114 (except S112).

In step S102, the CPU 11, as the model construction unit 140, sets the number of repetitions t =n+1. In the following, a description will be made about an embodiment in a case where the number of repetitions is at the tth repetition.

In step S104, the CPU 11, as the model construction unit 140, constructs a model for representing the relationship among the groups and for obtaining a prediction represented as a time series based on the set X of the groups and the set Y of the evaluation values of the groups. At the start of the process, X=xₖ and Y=yₖ are set. In the repetition, the set X of the groups and the set Y of the evaluation values are used which are stored in the evaluation accumulation unit 130. As one example of the model, a case of a Gaussian process will be described in the following.

When regression by the Gaussian process is used, an unknown index y can be inferred as a probability distribution in the form of a normal distribution from an arbitrary input x. In other words, an average μ(x) of prediction values and a variance σ(x) of the prediction values with respect to the evaluation value can be obtained. The variance of the prediction values represents a certainty factor about the prediction value.

In such a manner, the prediction as an output of the model is represented in a form of a probability density distribution. In the Gaussian process, a function referred to as kernel representing the relationship between plural pieces of data (groups) xₐ and x_{b} is used. The pieces of data xₐ and x_{b} are arbitrary groups included in X. As the kernel, any kernel may be used which can represent a time series. One example of a kernel which can be applied to a case where the occurrence time point of the reference event is set as an input is a linear functional kernel which is expressed by the following expression (1) in a case where smoothing by a Gaussian distribution is used.

$$\begin{matrix}[ Math . 1 ] & \\ κ ( {x}_{a} , {x}_{b} ) = {\sum }_{i , j} {{e}^{- {( {t}_{a , i} - {t}_{b , j} )}^{2} / 2 σ}}^{2} & ( 1 )\end{matrix}$$

Here, a term a denotes a hyperparameter which takes a real number greater than zero. The term a denotes point estimation to the value at which the marginal likelihood of the Gaussian process becomes the maximum. Terms t_{a,i}(i=1, 2, . . . ) and t_{b,j}(j=1, 2, . . . ) denote the occurrence time points of the reference events. It is assumed that i and j move to the numbers of elements of xₐ and x_{b}. The numbers of elements denote the numbers of reference events as elements of vectors included in xₐ and x_{b}. The kernel of the following expression (2) may be used for normalization.

$$\begin{matrix}[ Math . 2 ] & \\ κ ( {x}_{a} , {x}_{b} ) = \frac{κ ( {x}_{a} , {x}_{b} )}{\sqrt{κ ( {x}_{a} , {x}_{a} ) κ ( {x}_{b} , {x}_{b} )}} & ( 2 )\end{matrix}$$

As described above, the model of the Gaussian process is defined by using the kernel which corresponds to the reference event, is for representing the relationship between the groups, and is expressed by the occurrence time points (t_{a,i}, t_{b,j}) of the reference events between the groups.

Note that in the above, a case where one kind of reference event is provided is described, but use of kernel is not limited to this. For example, in a case where plural kinds of reference events are provided, as one example, a kernel may be used in a manner such that the value of the kernel of expression (1) or expression (2) is calculated for each kind of reference event and the values of the kernels of the respective kinds of reference events are added together. For example, in a case where two kinds of reference events are provided, x_{a,1} and x_{b,1} are set as time points when a first reference event occurs, x_{a,2} and x_{b,2} are set as time points when a second reference event occurs, and the kernel can thereby be set as follows.

[Math. 3]

k(xₐ, x_{b})=k(x_{a,1}, x_{b,1})+k(x_{a,2}, x_{b,2}) (3)

Further, in a case where additional information such as position information is attached to the reference event, the kernel is expressed while further including the additional information of the reference event. As one example, when the reference event is expressed by a kernel referred to as Gaussian kernel, the kernel can be configured as follows. Here, x_{a,e,i}(i=1, 2, . . . ) and x_{b,e,j}(j=1, 2, . . . ) denote additional information, which indicates position information or the like of positions where the reference event occurs. Terms i and j move from one to the numbers of elements of xₐ and x_{b}.

$$\begin{matrix}[ Math . 4 ] & \\ κ ( {x}_{a} , {x}_{b} ) = {\sum }_{i , j} {{e}^{- {( {t}_{a , i} - {t}_{b , j} )}^{2} / 2 σ}}^{2} {e}^{- {( {x}_{a , e , i} - {x}_{b , e , j} )}^{2} / 2 {σ}^{2}} & ( 4 )\end{matrix}$$

In step S106, the CPU 11, as the parameter determination unit 150, acquires present situation data, that is, one or more occurrence time points of the reference events from the outside. The reference events acquired here are the reference events which are recorded from the point when the intervention in the repetition is executed and an action of the reference event occurs to the present point. In other words, the present time point is set as t=0, and reference event series t₁, t₂, . . . are acquired.

In step S108, the CPU 11, as the parameter determination unit 150, determines the next group including the next intervention timing based on the acquired occurrence time points of the reference events, the constructed model, and the acquisition function. The acquisition function is an acquisition function for obtaining the next intervention timing. Details will be described in the following.

The constructed model is a model of a Gaussian process. Thus, when the acquired occurrence time point of the reference event is input to this model, the average μ(x) and variance σ(x) of the prediction values can be obtained as the prediction from the model. Accordingly, the parameter determination unit 150 selects the group xₜ₊₁ including the next intervention timing τₜ₊₁ as a parameter to be evaluated from the prediction by the model. For this selection, the parameter determination unit 150 performs numeralization of the degree to which the parameter of the prediction value is actually evaluated. A function for performing this numeralization is referred to as acquisition function α(x). The acquisition function α(x) is often a function using the average μ(x) and the variance α(x) of the prediction values predicted by the model, but an arbitrary function may be used. One example of the acquisition function is an upper confidence bound expressed by the following expression (5). Here, β(t) is a parameter and is set as β(t)=log t, as one example.

[Math. 5]

α(x)=μ(x)+\sqrt{β(t)}σ(x) (5)

Expression (5) is an expression in a case of performing maximization, but μ(x) may be substituted by—μ(x) in a case of performing minimization. Then, the next intervention timing is selected such that the acquisition function becomes the maximum. In other words, the parameter determination unit 150 selects the next intervention timing τₜ₊₁ by the following expression (6).

$$\begin{matrix}[ Math . 6 ] & \\ {τ}_{t + 1} = {arg max}_{τ ∈ [ {T}_{l} , {T}_{h} ]} α ( x = ( {t}_{1} + τ , {t}_{2} + τ , … ) ) & ( 6 )\end{matrix}$$

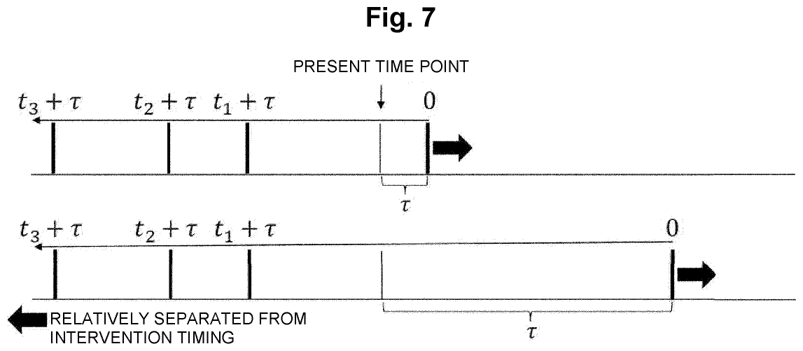

FIG. 7 is a diagram illustrating the relationship between the occurrence time point of the reference event and the intervention timing desired to be obtained. As illustrated in FIG. 7, a case is assumed where in a case where the reference event series t₁, t₂, . . . are acquired in the above and plural reference events are acquired, the time point after a time τ elapses from the present time point is set as the intervention timing. In this case, as the reference events occur much earlier than the present time point as t₁, t₂, . . . , the distances from the intervention timing relatively becomes longer. Expression (6) is a function for selecting the intervention timing τₜ₊₁ such that the acquisition function α(x) is maximized (or minimized). In expression (6), a term T₁ denotes the earliest intervention timing in an output of the model, a term Tₕ denotes the latest intervention timing in the output of the model, and those are arbitrary timings. Thus, a term τ denotes a value for defining the length of time from the present time point to the next intervention timing. The term τ may be defined by using the average μ(x) and the variance σ(x) as references, for example. As τ more approaches Tₕ, the distance between the reference event and the intervention timing relatively becomes longer. Similarly, as τ more approaches T₁, the distance between the reference event and the intervention timing relatively becomes shorter. In the above expression (6), the intervention timing resulting from addition of τ to a reference event t₁ is obtained. In other words, for each of reference events (t₁, t₂, . . . ), the time point a predetermined time point τ after the acquired occurrence time point of the reference event is obtained as the intervention timing. Then, among the intervention timings respectively obtained for the reference events, the intervention timing which maximizes the acquisition function of the above expression (5) is selected as the next intervention timing τₜ₊₁. In such a manner, the function of expression (6) represents the relationship between the occurrence time point of the reference event and the prediction value output from the model. Thus, the next intervention timing Tₜ₊₁ selected in such a manner may be considered to be a timing which is defined by the relationship between the reference event and the model with the present time point being a base point and at which the next intervention is performed. In other words, the group xₜ₊₁ determined here is a group of the selected next intervention timing τₜ₊₁ and the acquired reference event series t₁, t₂, . . .

In step S110, the CPU 11, as the parameter determination unit 150, assesses whether or not the reference event occurs before the determined next intervention timing τₜ₊₁. In a case where the reference event occurs before, the CPU 11 returns to step S106, acquires the occurrence time points of the reference events including the occurred reference event, performs a process of step S108, and again performs determination of the next group including the next intervention timing. In a case where the reference event does not occur before, the CPU 11 moves to step S112. In a case where another reference event occurs before the intervention, a present situation becomes different from a situation which is assumed when the intervention timing τₜ₊₁ is determined in step S108. Then, the CPU 11 again returns to step S106 and again determines τₜ₊₁ from new data. Accordingly, the intervention can be performed after whether the intervention can be performed before a situation of a person is changed. In a case where another reference event does not occur, the CPU 11 moves to step S170. However, in some embodiments, the process may skip this step S110 and move to step S112 even when another reference event occurs.

In step S112, the CPU 11, as the evaluation unit 120, executes the intervention at the next intervention timing τₜ₊₁ in the next group determined in step S108. The intervention is performed by using the data acquired in step S100.

In step S114, the CPU 11, as the evaluation unit 120, calculates an evaluation value yₜ₊₁ of the group xₜ₊₁ obtained as the next group. The group of the next group xₜ₊₁ and the evaluation value yₜ₊₁ is stored in the evaluation accumulation unit 130. The group xₜ₊₁ and the evaluation value yₜ₊₁ which are obtained here are, by repetition, sequentially accumulated in the set X of the groups and the set Y of the evaluation values of the evaluation accumulation unit 130. The set X of the groups and the set Y of the evaluation values which are accumulated in such a manner are examples of a set of groups and a set of evaluation values which are obtained by each of the repeatedly performed interventions.

In step S116, the CPU 11, as the assessment unit 160, assesses whether or not a predetermined condition is satisfied. When the condition is satisfied, the CPU 11 finishes the process; however, when the condition is not satisfied, the CPU 11 moves to step S118, performs an increment as t=t+1, returns to step S104, and repeats the process.

As described in the foregoing, the optimization device 100 of the present embodiment can estimate an optimal intervention timing in accordance with a reference event.

Note that the optimization process that the CPU executes by reading software (program) in the above embodiments may be executed by various kinds of processors other than the CPU. Examples of processors in this case may include a PLD (programmable logic device) in which a circuit configuration is changeable after manufacturing such as an FPGA (field-programmable gate array), a dedicated electric circuit as a processor having a circuit configuration dedicatedly designed for execution of a specific process such as an ASIC (application specific integrated circuit), and so forth. Further, the optimization process may be executed by one of those various kinds of processors or may be executed by a combination of two processors of the same kind or different kinds (for example, plural FPGAs, a combination of a CPU and an FPGA, or the like). Further, hardware structures of those various kinds of processors are, more specifically, electric circuits in which circuit elements such as semiconductor elements are combined together.

Further, in the above embodiments, a description is made about a mode in which the optimization program is in advance stored (installed) in the storage 14; however, modes are not limited to this. The program may be provided in a form in which the program is recorded in a non-transitory storage medium such as a CD-ROM (compact disk read only memory), a DVD-ROM (digital versatile disk read only memory), or a USB (universal serial bus) memory. Further, a form is possible in which the program is downloaded from an external device via a network.

As for the above embodiments, the following supplement will further be disclosed.

(Supplementary Item 1)

An optimization device configured to include:

a memory; and

at least one processor being connected with the memory, in which

the processor

constructs a model for representing a relationship among groups and for obtaining a prediction represented as a time series based on a set of groups of occurrence time points of reference events as events occurring before interventions and intervention timings as time points to cause the interventions and a set of evaluation values of the groups,

acquires one or more occurrence time points of the reference events and determines the next group including a next intervention timing based on the acquired occurrence time points of the reference events, the constructed model, and an acquisition function for obtaining the next intervention timing,

performs the intervention at the next intervention timing in the determined next group and calculates the evaluation value of the group obtained as the next group, and

causes construction of the model, determination of the group, and calculation of the evaluation value to be repeated until a predetermined condition is satisfied, and

in the repetition, the model is constructed based on the set of the groups and the set of the evaluation values which are obtained in each of the repeatedly performed interventions.

(Supplementary Item 2)

A non-transitory storage medium storing an optimization program causing a computer to execute:

constructing a model for representing a relationship among groups and for obtaining a prediction represented as a time series based on a set of groups of occurrence time points of reference events as events occurring before interventions and intervention timings as time points to cause the interventions and a set of evaluation values of the groups;

acquiring one or more occurrence time points of the reference events and determining the next group including a next intervention timing based on the acquired occurrence time points of the reference events, the constructed model, and an acquisition function for obtaining the next intervention timing;

performing the intervention at the next intervention timing in the determined next group and calculating the evaluation value of the group obtained as the next group; and

causing construction of the model, determination of the group, and calculation of the evaluation value to be repeated until a predetermined condition is satisfied, in which

in the repetition, the model is constructed based on the set of the groups and the set of the evaluation values which are obtained in each of the repeatedly performed interventions.

### REFERENCE SIGNS LIST

100 optimization device

110 evaluation data accumulation unit

120 evaluation unit

130 evaluation accumulation unit

140 model construction unit

150 parameter determination unit

160 assessment unit

1. An optimization device comprising circuit configured to execute a method comprising:
constructing a model for representing a relationship among groups and for obtaining a prediction represented as a time series based on a set of groups of occurrence time points of reference events as events occurring before interventions and intervention timings as time points to cause the interventions and a set of evaluation values of the groups;
acquiring one or more occurrence time points of the reference events;
determining the next group including a next intervention timing based on the acquired occurrence time points of the reference events, the constructed model, and an acquisition function for obtaining the next intervention timing;
performing the intervention at the next intervention timing in the determined next group;
calculating the evaluation value of the group obtained as the next group; and
an assessment unit that causes construction of the model, determination of the group, and calculation of the evaluation value to be repeated until a predetermined condition is satisfied, wherein
in the repetition, the model is constructed based on the set of the groups and the set of the evaluation values which are obtained in each of the repeatedly performed interventions.

2. The optimization device according to claim 1, wherein the model is defined by using a kernel which corresponds to the reference event, is for representing the relationship among the groups, and is expressed by the occurrence time points of the reference events among the groups.

3. The optimization device according to claim 2, wherein in a case where plural kinds of the reference events are provided, the kernel is used in a manner such that values of kernels of the respective kinds of reference events are added together.

4. The optimization device according to claim 2, wherein
the kernel is expressed while further including additional information of the reference event.

5. The optimization device according to claim 1, wherein
in a case where the reference event occurs before the determined next intervention timing, the parameter determination unit acquires the occurrence time points of the reference events including the occurred reference event and again performs the determination.

6. The optimization device according to claim 1, wherein
the model outputs an average and a variance of prediction values as the prediction,
a function using the average and the variance of the prediction values is used as the acquisition function, and
in a case where plural reference events are acquired, a time point a predetermined time point after the acquired occurrence time point of the reference event is obtained as the intervention timing for each of the reference events, and the next intervention timing is determined by using a function which selects the intervention timing such that the acquisition function is maximized or minimized.

7. A computer-implemented method for optimizing, comprising:
constructing a model for representing a relationship among groups and for obtaining a prediction represented as a time series based on a set of groups of occurrence time points of reference events as events occurring before interventions and intervention timings as time points to cause the interventions and a set of evaluation values of the groups;
acquiring one or more occurrence time points of the reference events and determining the next group including a next intervention timing based on the acquired occurrence time points of the reference events, the constructed model, and an acquisition function for obtaining the next intervention timing;
performing the intervention at the next intervention timing in the determined next group and calculating the evaluation value of the group obtained as the next group; and
causing construction of the model, determination of the group, and calculation of the evaluation value to be repeated until a predetermined condition is satisfied, wherein
in the repetition, the model is constructed based on the set of the groups and the set of the evaluation values which are obtained in each of the repeatedly performed interventions.

8. A computer-readable non-transitory recording medium storing computer-executable program instructions that when executed by a processor cause a computer to execute a method comprising:
constructing a model for representing a relationship among groups and for obtaining a prediction represented as a time series based on a set of groups of occurrence time points of reference events as events occurring before interventions and intervention timings as time points to cause the interventions and a set of evaluation values of the groups;
acquiring one or more occurrence time points of the reference events and determining the next group including a next intervention timing based on the acquired occurrence time points of the reference events, the constructed model, and an acquisition function for obtaining the next intervention timing;
performing the intervention at the next intervention timing in the determined next group and calculating the evaluation value of the group obtained as the next group; and
causing construction of the model, determination of the group, and calculation of the evaluation value to be repeated until a predetermined condition is satisfied, wherein in the repetition, the model is constructed based on the set of the groups and the set of the evaluation values which are obtained in each of the repeatedly performed interventions.

9. The optimization device according to claim 2, wherein
in a case where the reference event occurs before the determined next intervention timing, the parameter determination unit acquires the occurrence time points of the reference events including the occurred reference event and again performs the determination.

10. The computer-implemented method according to claim 7, wherein
the model is defined by using a kernel which corresponds to the reference event, is for representing the relationship among the groups, and is expressed by the occurrence time points of the reference events among the groups.

11. The computer-implemented method according to claim 7, wherein
in a case where the reference event occurs before the determined next intervention timing, the parameter determination unit acquires the occurrence time points of the reference events including the occurred reference event and again performs the determination.

12. The computer-implemented method according to claim 7, wherein
the model outputs an average and a variance of prediction values as the prediction,
a function using the average and the variance of the prediction values is used as the acquisition function, and
in a case where plural reference events are acquired, a time point a predetermined time point after the acquired occurrence time point of the reference event is obtained as the intervention timing for each of the reference events, and the next intervention timing is determined by using a function which selects the intervention timing such that the acquisition function is maximized or minimized.

13. The computer-readable non-transitory recording medium according to claim 8, wherein
the model is defined by using a kernel which corresponds to the reference event, is for representing the relationship among the groups, and is expressed by the occurrence time points of the reference events among the groups.

14. The computer-readable non-transitory recording medium according to claim 8, wherein
in a case where the reference event occurs before the determined next intervention timing, the parameter determination unit acquires the occurrence time points of the reference events including the occurred reference event and again performs the determination.

15. The computer-readable non-transitory recording medium according to claim 8, wherein
the model outputs an average and a variance of prediction values as the prediction,
a function using the average and the variance of the prediction values is used as the acquisition function, and
in a case where plural reference events are acquired, a time point a predetermined time point after the acquired occurrence time point of the reference event is obtained as the intervention timing for each of the reference events, and the next intervention timing is determined by using a function which selects the intervention timing such that the acquisition function is maximized or minimized.

16. The computer-implemented method according to claim 10, wherein
in a case where plural kinds of the reference events are provided, the kernel is used in a manner such that values of kernels of the respective kinds of reference events are added together.

17. The computer-implemented method according to claim 10, wherein
the kernel is expressed while further including additional information of the reference event.

18. The computer-implemented method according to claim 10, wherein
in a case where the reference event occurs before the determined next intervention timing, the parameter determination unit acquires the occurrence time points of the reference events including the occurred reference event and again performs the determination.

19. The computer-readable non-transitory recording medium according to claim 13, wherein
in a case where plural kinds of the reference events are provided, the kernel is used in a manner such that values of kernels of the respective kinds of reference events are added together.

20. The computer-readable non-transitory recording medium according to claim 13, wherein
the kernel is expressed while further including additional information of the reference event, and wherein
in a case where the reference event occurs before the determined next intervention timing, the parameter determination unit acquires the occurrence time points of the reference events including the occurred reference event and again performs the determination.
